(19) United States
(12) Patent Application Publication
(10) Pub. No.: US 2017/0094403 A1
(43) Pub. Date: Mar. 30, 2017

(54) ACOUSTIC FILTER FOR OMNIDIRECTIONAL LOUDSPEAKER

(71) Applicant: Samsung Electronics Co., Ltd., Suwon-si (KR)

(72) Inventors: Lakshmikanth Tipparaju, Valencia, CA (US); Allan Devantier, Newhall, CA (US); William Decanio, Valencia, CA (US); Andri Bezzola, Pasadena, CA (US)

(21) Appl. No.: 15/141,594

(22) Filed: Apr. 28, 2016

Related U.S. Application Data
(60) Provisional application No. 62/233,927, filed on Sep. 28, 2015.

(51) Int. Cl. H04R 1/24; H04R 1/32; H04R 1/02; H04R 1/28

(52) U.S. Cl. CPC H04R 1/24; H04R 1/2803; H04R 1/323; H04R 1/02

(57) ABSTRACT

One embodiment provides an omnidirectional loudspeaker comprising a phase plug and an acoustic resonator within the phase plug. The acoustic resonator comprises acoustic damping material.

### CROSS-REFERENCE TO RELATED APPLICATIONS

The present application claims priority to U.S. Provisional Patent Application No. 62/233,927, filed on Sep. 28, 2015. Further, the present application is related to commonly-assigned, co-pending U.S. Non-Provisional patent application entitled “THREE HUNDRED AND SIXTY DEGREE HORN FOR OMNIDIRECTIONAL LOUDSPEAKER” (Atty. Docket No. SAM2-P.e128 (DMS15-AU02-A1)), filed on the same day as the present application. Both patent applications are hereby incorporated by reference in its entirety.

### TECHNICAL FIELD

One or more embodiments relate generally to loudspeakers, and in particular, a physical acoustic filter for an omnidirectional loudspeaker.

### BACKGROUND

A loudspeaker reproduces audio when connected to a receiver (e.g., a stereo receiver, a surround receiver, etc.), a television (TV) set, a radio, a music player, an electronic sound producing device (e.g., a smartphone), video players, etc. A loudspeaker may comprise a speaker cone, a horn or another type of device that forwards most of the audio reproduced towards the front of the loudspeaker.

### SUMMARY

One embodiment provides an omnidirectional loudspeaker comprising a phase plug and an acoustic resonator within the phase plug. The acoustic resonator comprises acoustic damping material.

Another embodiment provides a method for producing a phase plug for an omnidirectional loudspeaker. The method comprises identifying resonances in a cavity of the omnidirectional loudspeaker to remove and fabricate a phase plug for removing acoustic amplification generated by the resonances. The phase plug comprises an acoustic resonator including acoustic damping material.

One embodiment provides a method for removing acoustic amplification in a cavity between a diaphragm and a phase plug of an omnidirectional loudspeaker. The method comprises generating, utilizing a sound source of the omnidirectional loudspeaker, sound and removing acoustic amplification generated by resonances in the cavity by attenuating, utilizing an acoustic resonator of the phase plug, the sound at a pre-selected frequency. The acoustic resonator comprises an acoustic damping material.

These and other features, aspects and advantages of the one or more embodiments will become understood with reference to the following description, appended claims and accompanying figures.

### BRIEF DESCRIPTION OF THE DRAWINGS

FIG. 1 illustrates an exemplary cross-section of an omnidirectional loudspeaker.

FIG. 2 illustrates a cross-section of an example modified phase plug for an omnidirectional loudspeaker, in accordance with an embodiment.

FIG. 3 illustrates a cross-section of an example modified phase plug for an omnidirectional loudspeaker, in accordance with an embodiment.

FIG. 4 is an example graph illustrating multiple frequency response curves, in accordance with one embodiment.

FIG. 5A illustrates a cross-section of another example modified phase plug for an omnidirectional loudspeaker, wherein the modified phase plug includes a flat shaped absorber without a perforated plate, in accordance with an embodiment.

FIG. 5B illustrates a cross-section of another example modified phase plug for an omnidirectional loudspeaker, wherein the modified phase plug includes a flat shaped absorber with a perforated plate, in accordance with an embodiment.

FIG. 5C illustrates a cross-section of another example modified phase plug for an omnidirectional loudspeaker, wherein the modified phase plug includes a curved shaped absorber without a perforated plate, in accordance with an embodiment.

FIG. 5D illustrates a cross-section of another example modified phase plug for an omnidirectional loudspeaker, wherein the modified phase plug includes a curved shaped absorber with a perforated plate, in accordance with an embodiment.

FIG. 5E is another example graph illustrating multiple frequency response curves, in accordance with one embodiment.

FIG. 5F illustrates a top view of an example modified phase plug for an omnidirectional loudspeaker, wherein the modified phase plug includes a curved shaped absorber with a perforated plate, in accordance with an embodiment.

FIG. 5G illustrates a top view of an example modified phase plug for an omnidirectional loudspeaker, wherein the modified phase plug includes a flat shaped absorber with a perforated plate, in accordance with an embodiment.

FIG. 5H illustrates sound pressure wave fronts around an omnidirectional loudspeaker in operation, in accordance with an embodiment.

FIG. 6A illustrates a cross-section of an example protruding phase plug for an omnidirectional loudspeaker, in accordance with an embodiment.

FIG. 6B illustrates a cross-section of an example protruding phase plug for an omnidirectional loudspeaker, in accordance with an embodiment.

FIG. 6C is another example graph illustrating multiple frequency response curves, in accordance with one embodiment.

FIG. 6D illustrates a cross-section of the protruding phase plug with a perforated plate, in accordance with an embodiment.

FIG. 6E illustrates a cross-section of the protruding phase plug with a perforated plate and an extended absorber, in accordance with an embodiment.

FIG. 6F illustrates a cross-section of the protruding phase plug with an extended absorber and without a perforated plate, in accordance with an embodiment.

FIG. 6G each illustrate a cross-section of an example protruding phase plug for an omnidirectional loudspeaker, in accordance with an embodiment.

FIG. 6H illustrates a cross-section of the protruding phase plug with a perforated plate, in accordance with an embodiment.

FIG. 7A illustrates a cross-section of an example modified phase plug comprising a cylindrical shaped resonator, in accordance with an embodiment.

FIG. 7B illustrates a cross-section of an example modified phase plug comprising a spherical shaped resonator, in accordance with an embodiment.

FIG. 7C illustrates a cross-section of an example modified phase plug comprising a Helmholtz resonator, in accordance with an embodiment.

FIG. 7D illustrates a cross-section of an example modified phase plug comprising a rectangular prism shaped resonator, in accordance with an embodiment.

FIG. 7E illustrates a cross-section of an example modified phase plug comprising an irregular shaped resonator, in accordance with an embodiment.

FIG. 8 is an example flowchart of a manufacturing process for producing a phase plug for an omnidirectional loudspeaker, in accordance with an embodiment of the invention.

FIG. 9 is an example flowchart for removing acoustic amplification in a cavity between a diaphragm and a phase plug of an omnidirectional loudspeaker, in accordance with an embodiment of the invention.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. The term “on” includes when components or elements are in physical contact and also when components or elements are separated by one or more intervening components or elements. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to loudspeakers, and in particular, a physical acoustic filter for an omnidirectional loudspeaker. One embodiment provides an omnidirectional loudspeaker comprising a phase plug and an acoustic resonator within the phase plug. The acoustic resonator comprises acoustic damping material.

Another embodiment provides a method for producing a phase plug for an omnidirectional loudspeaker. The method comprises identifying resonances in a cavity of the omnidirectional loudspeaker to remove and fabricate a phase plug for removing acoustic amplification generated by the resonances. The phase plug comprises an acoustic resonator including acoustic damping material.

One embodiment provides a method for removing acoustic amplification in a cavity between a diaphragm and a phase plug of an omnidirectional loudspeaker. The method comprises generating, utilizing a sound source of the omnidirectional loudspeaker, sound and removing acoustic amplification generated by resonances in the cavity by attenuating, utilizing an acoustic resonator of the phase plug, the sound at a pre-selected frequency. The acoustic resonator comprises an acoustic damping material.

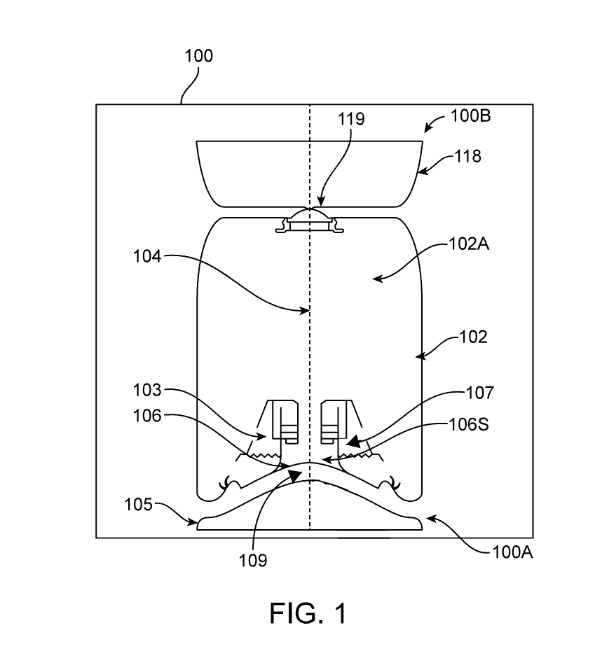

FIG. 1 illustrates an exemplary cross-section of an omnidirectional loudspeaker 100. The loudspeaker 100 is rotationally symmetric about an axis of symmetry 104. The loudspeaker 100 comprises a first axisymmetric loudspeaker enclosure 102 (“first enclosure”), a second axisymmetric loudspeaker enclosure 118 (“second enclosure”), and a phase plug 105. The phase plug 105 is positioned at a bottom section 100A of the loudspeaker 100. The second enclosure 118 is positioned at a top section 100B of the loudspeaker 100. The first enclosure 102 is positioned in between the second enclosure 118 and the phase plug 105. A cavity (i.e., a gap) 109 separates a bottom section of the first enclosure 102 and a top section of the phase plug 105.

A sound source is disposed within the first enclosure 102. In one embodiment, the sound source comprises a woofer loudspeaker driver 103. In another embodiment, the sound source comprises a tweeter loudspeaker driver 119 positioned/mounted axially inside the first enclosure 102 or the second enclosure 118.

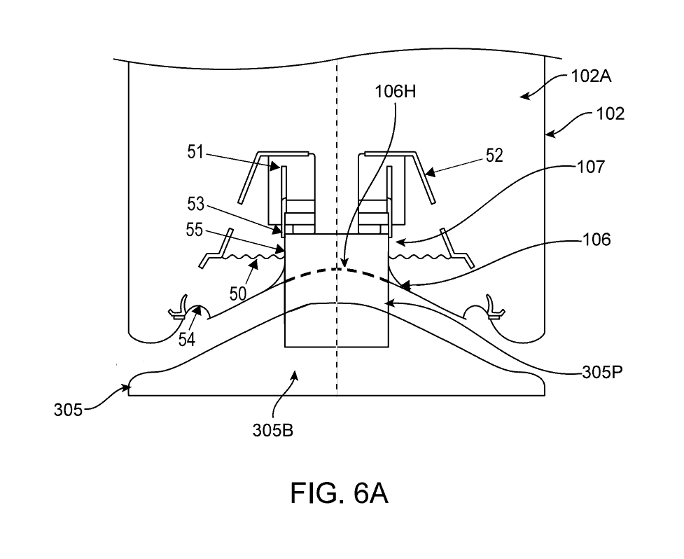

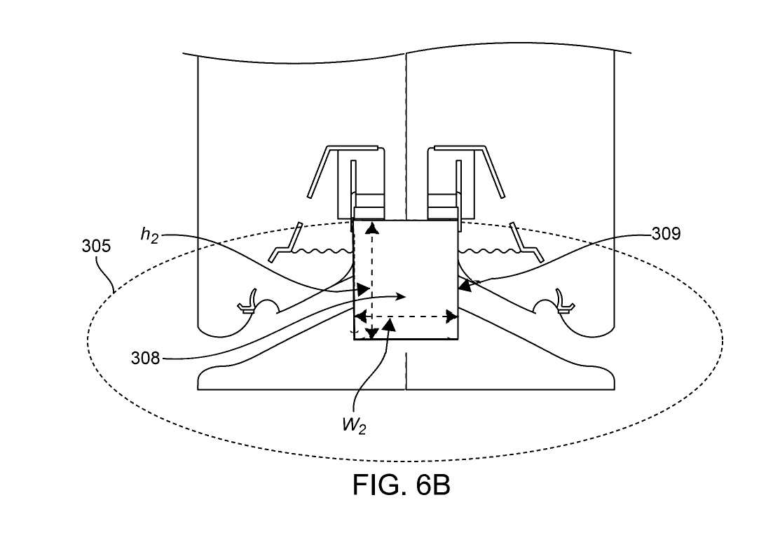

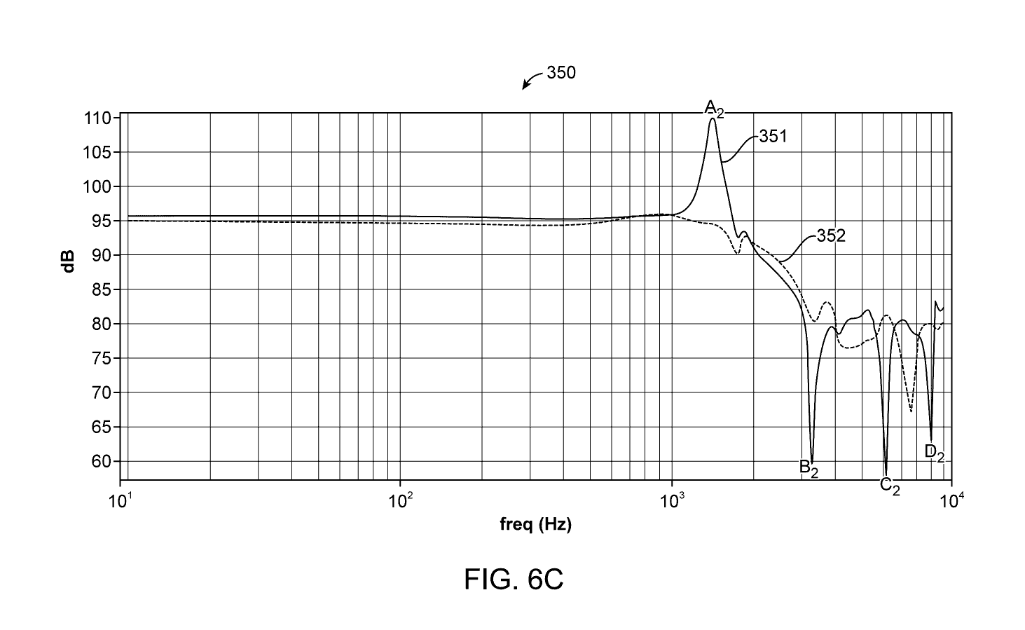

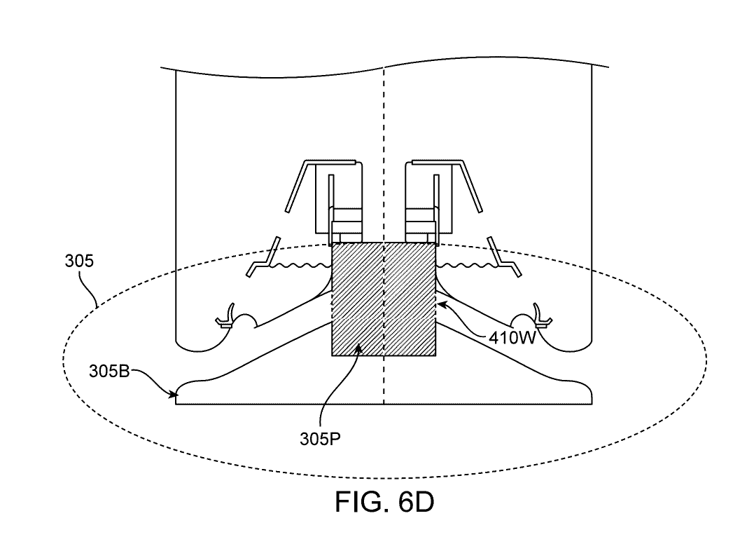

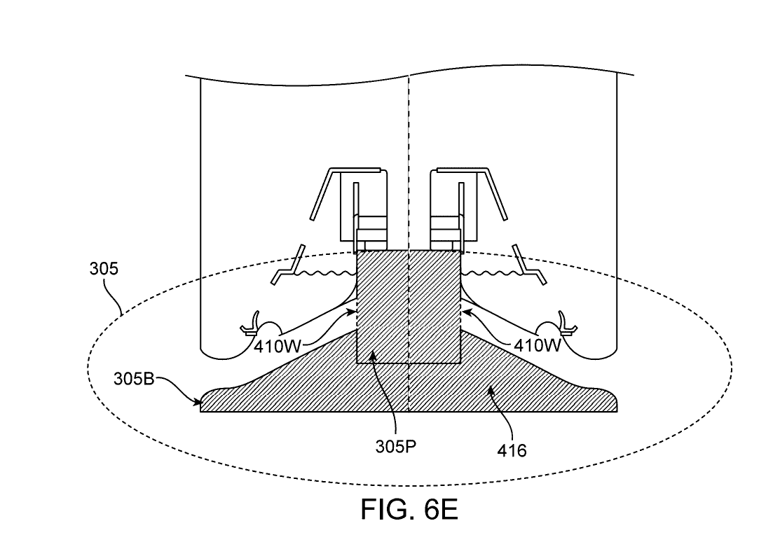

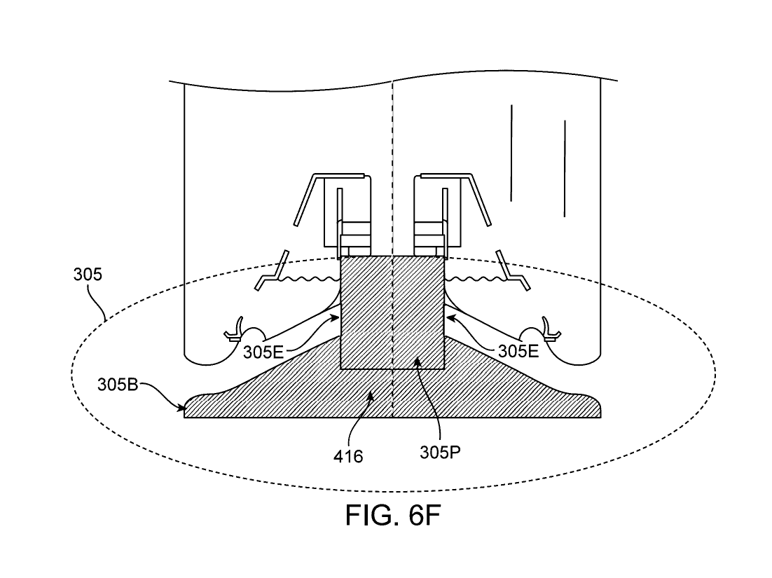

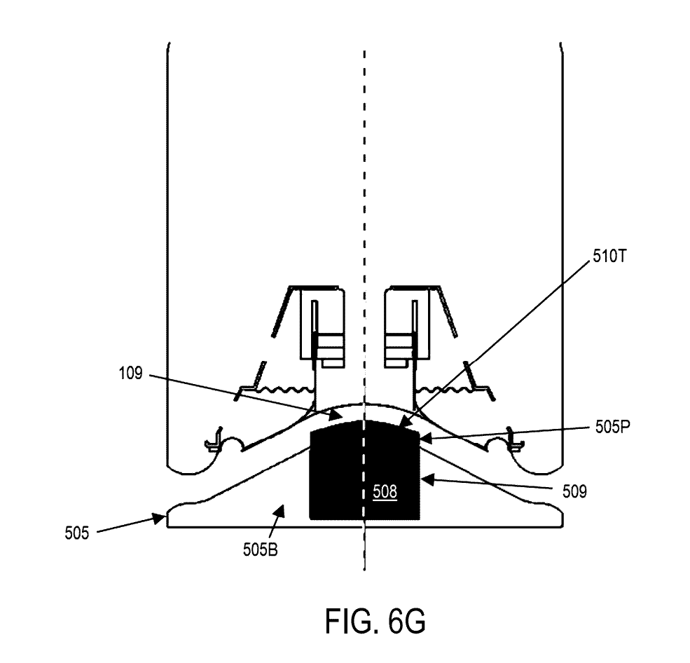

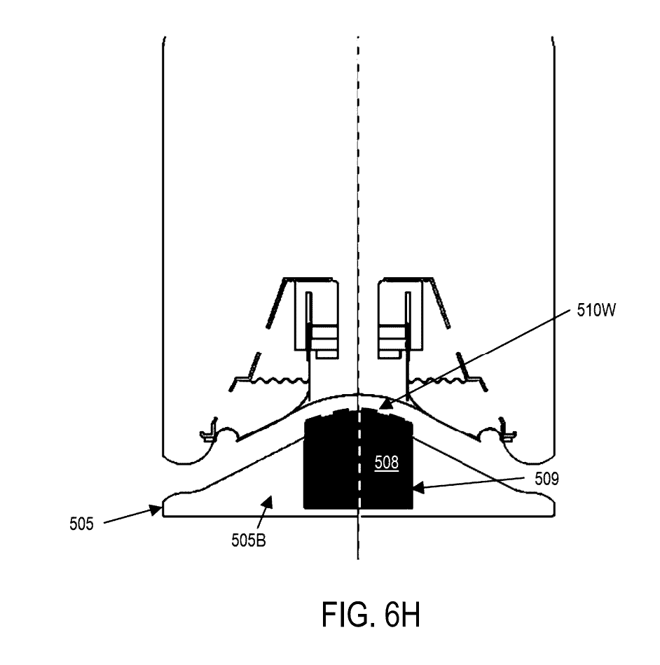

The first enclosure 102 further comprises a diaphragm 106 and a transducer 107. With reference to FIG. 6A, the transducer 107 comprises a motor structure 51, a voice coil 53, a voice coil former 55, a spider structure 50, a surround structure 54, and a frame structure 52. The loudspeaker 100 reproduces audio (i.e., emits sound) only when it is powered on. The diaphragm 106 is an example radiating surface that vibrates when the loudspeaker 100 is reproducing audio. When the loudspeaker 100 is not reproducing audio, the diaphragm 106 is at a rest position, as shown in FIG. 1. A region 106S of space separates the diaphragm 106 and the transducer 107. A portion of the phase plug 105 is positioned directly across from the diaphragm 106, in the path of sound propagation.

During reproduction of audio, the loudspeaker 100 may exhibit large peaks and dips in frequency response curves due to resonances in the cavity 109. Resonances are typically equalized using conventional methods such as Digital Signal Processing (DSP), equalization circuits, etc. These conventional methods, however, are ineffective at removing resonances in the cavity 109. Instead, these conventional methods attenuate a signal going into the loudspeaker 100 at frequencies of the resonances in the cavity 109. The resonances in the cavity 109 act as an acoustic amplifier that re-amplifies the attenuated signal to a desired level. Therefore, distortion components in a frequency region around the resonances in the cavity 109 are amplified by the resonances but are not attenuated by an equalizer, thereby negatively impacting sound quality of the loudspeaker 100.

One or more embodiments of the invention provide a physical acoustic filter for a loudspeaker providing omnidirectional sound distribution. In one embodiment, the acoustic filter comprises an acoustic resonator filled with sound absorbing material (i.e., acoustic damping material). The acoustic filter may be used to attenuate peaks and dips in frequency response curves for the loudspeaker at a specific frequency. The acoustic filter may also be used to attenuate resonances. For example, the acoustic filter may reduce distortion amplification and damp resonances in the cavity 109. The acoustic filter is positioned directly across one or more distortion inducing elements of the loudspeaker.

One embodiment provides a physical acoustic filter that may be integrated into a phase plug of a loudspeaker to attenuate one or more peaks in omnidirectional sound distribution. Acoustic damping characteristics of the sound absorbing material tunes a Q-factor of attenuation to a Q-factor of resonance to reduce dips in the sound distribution and dips in frequency response curves caused by resonances in the cavity 109. The acoustic filter allows a sound source of the loudspeaker to be used at a wider band of frequencies; otherwise, dips in frequency response curves around the resonances may severely limit bandwidth at which the loudspeaker can produce significant sound levels. Dips in frequency response curves are more difficult to equalize at a level of an input signal because additional energy is required to enhance the input signal. The acoustic filter reduces some of the acoustic phenomena that create dips in frequency response curves, thereby eliminating burden on an equalizer and enhancing sound quality.

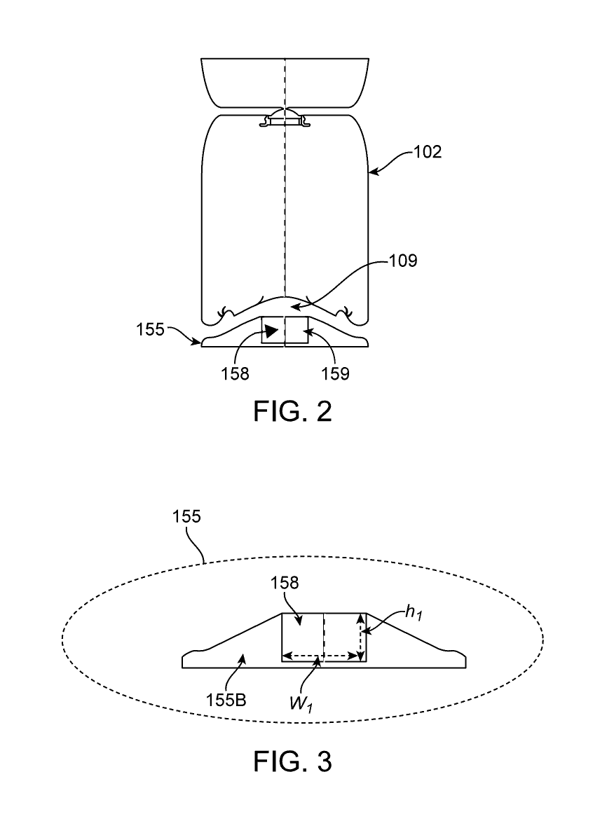

FIGS. 2-3 each illustrate a cross-section of an example modified phase plug 155 for an omnidirectional loudspeaker 100, in accordance with an embodiment. The modified phase plug 155 comprises a base 155B including an acoustic resonator 159 filled with acoustic damping material 158. The resonator 159 and the acoustic damping material 158 combined provide a physical acoustic filter.

In this specification, a₁ denotes an amount (i.e., quantity) of the acoustic damping material 158 used to fill the resonator 159, t₁ denotes a type of the acoustic damping material 158, w₁ denotes a first dimension (e.g., diameter) of the resonator 159, and h₁ denotes a second dimension (e.g., height/depth) of the resonator 159. The dimensions w₁ and h₁ of the resonator 159 and the amount a₁ of the acoustic damping material 158 are not limited to any specific range.

Examples of types of acoustic damping material 158 may include, but are not limited to, fiberglass, Dacron, rockwool, glasswool, foam (e.g., polyethylene foam), and mineral wool. The resonator 159 may comprise only one type of acoustic damping material 158 or a combination of different types of acoustic damping material 158. For example, in one embodiment, fiberglass is used to fully fill the resonator 159.

The resonator 159 is shaped/dimensioned such that the resonator 159 can be precisely tuned to attenuate sound at selected frequencies. Further, “sharpness” of attenuation is based on acoustic damping characteristics of the acoustic damping material 158. For example, if the acoustic damping material 158 has a small amount of acoustic damping, the resonator 159 is effective at attenuating a narrow band of frequencies (i.e., a high Q-factor of attenuation). As another example, if the acoustic damping material 158 has a higher amount of acoustic damping, the resonator 159 provides increased bandwidth at which sound is attenuated but decreased effectiveness (i.e., a low Q-factor of attenuation).

To manufacture the modified phase plug 155, a shape of the resonator 159, dimensions w₁ and h₁ of the resonator 159, type t₁ of acoustic damping material 158 to use, and amount a₁ of the acoustic damping material 158 to fill the resonator 159 with are determined based on an application and/or size of the loudspeaker 100.

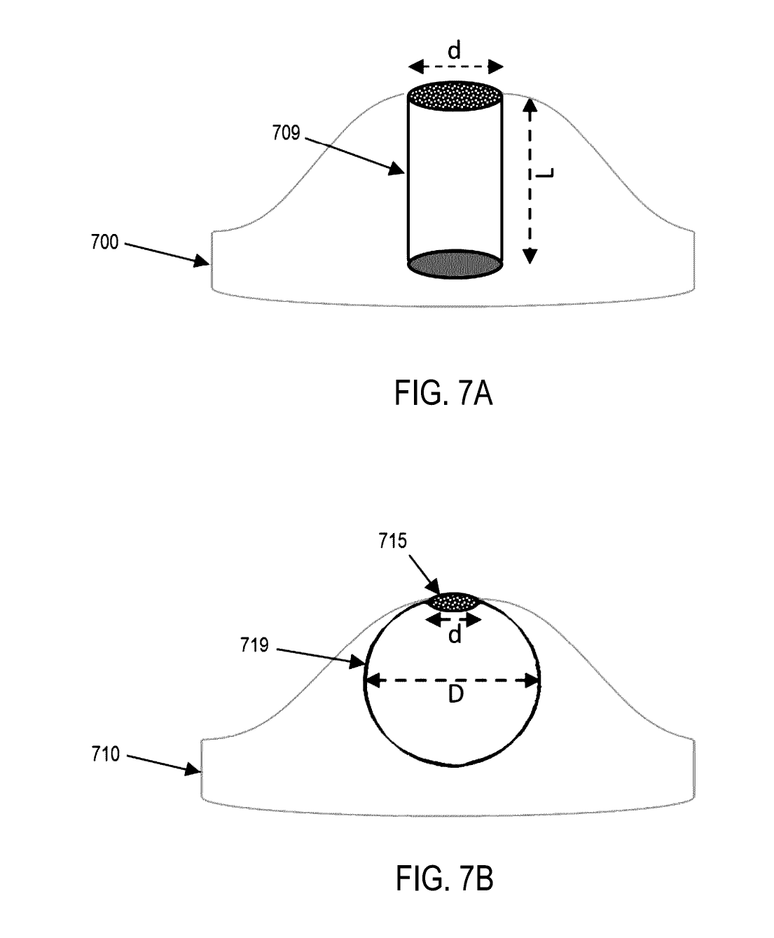

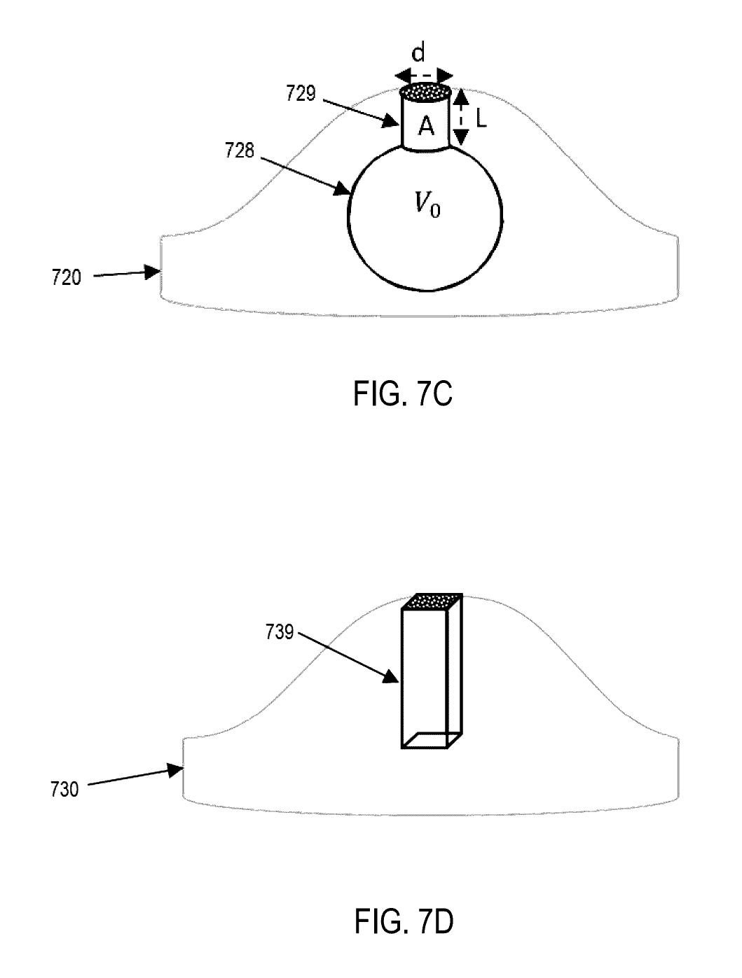

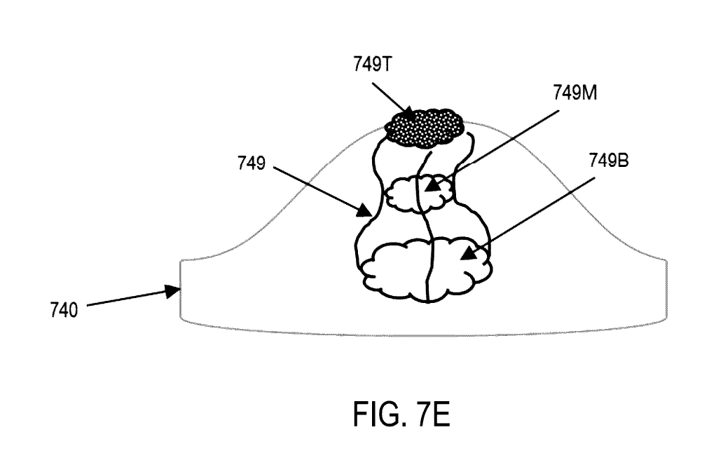

In one example embodiment, a cross-section of the resonator 159 has, but is not limited to, one of the following three-dimensional (3D) shapes: a sphere (see FIG. 7B as an example), a rectangular prism (see FIG. 7D as an example), a cylinder (see FIG. 7A as an example), an undefined shape (see FIG. 7E as an example), etc.

In one example implementation, the resonator 159 is a cylinder with a height/depth of 28 mm and a diameter of 21 mm.

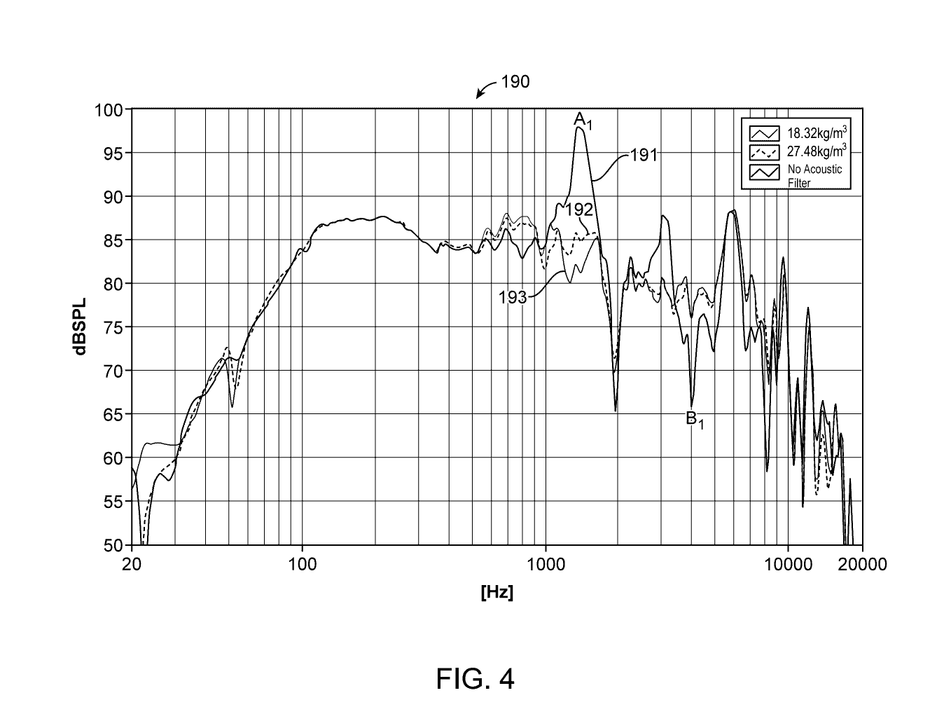

FIG. 4 is an example graph 190 illustrating multiple frequency response curves, in accordance with one embodiment. Specifically, the graph 190 shows a first frequency response curve 191 for a loudspeaker 100 without a physical acoustic filter, a second frequency response curve 192 for a loudspeaker 100 with a physical acoustic filter comprising acoustic damping material (e.g., fiberglass) of density 27.48 kg/m³, and a third frequency response curve 193 for a loudspeaker 100 with a physical acoustic filter comprising acoustic damping material (e.g., fiberglass) of density 18.32 kg/m³. The first frequency response curve 191 includes a peak A₁ around 1500 Hz and a dip B₁ around 4000 Hz. By comparison, as shown by the second and third frequency response curves 192 and 193, the peak A₁ around 1500 Hz is eliminated and the dip B₁ around 4000 Hz is greatly reduced for a loudspeaker 100 with a physical acoustic filter. Therefore, a physical acoustic filter provided by the modified phase plug 155 reduces magnitude of peaks and dips in a frequency response curve for a loudspeaker 100, thereby enhancing sound quality of the loudspeaker 100.

Further, as demonstrated by the second and third frequency response curves 192 and 193, the amount of acoustic damping material included in a physical acoustic filter also influences frequency response.

In this specification, the term “absorber” generally denotes an acoustic resonator filled with acoustic damping material (i.e., sound absorbing material).

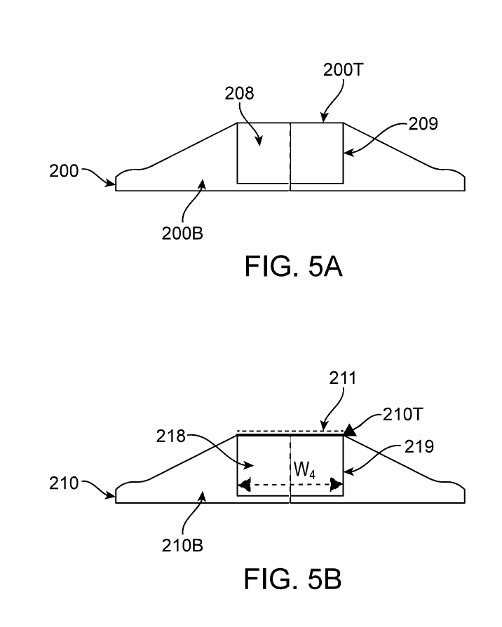

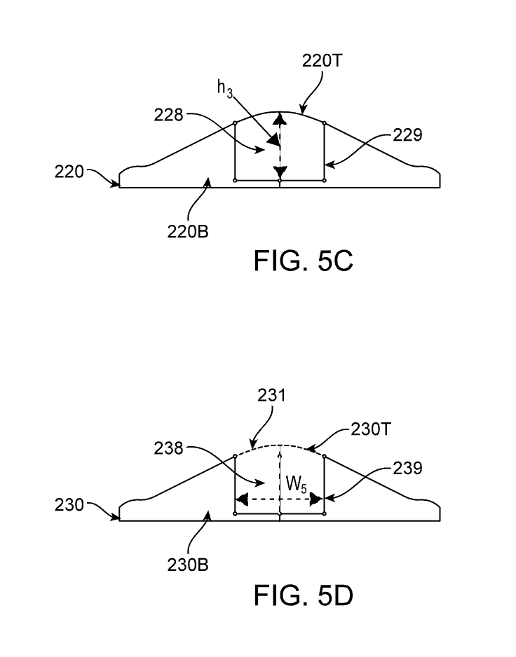

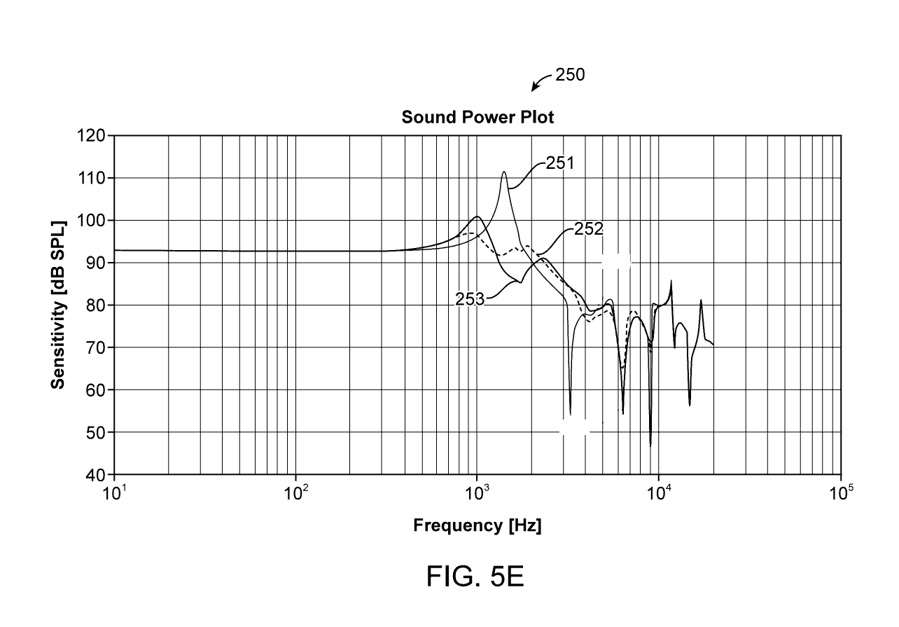

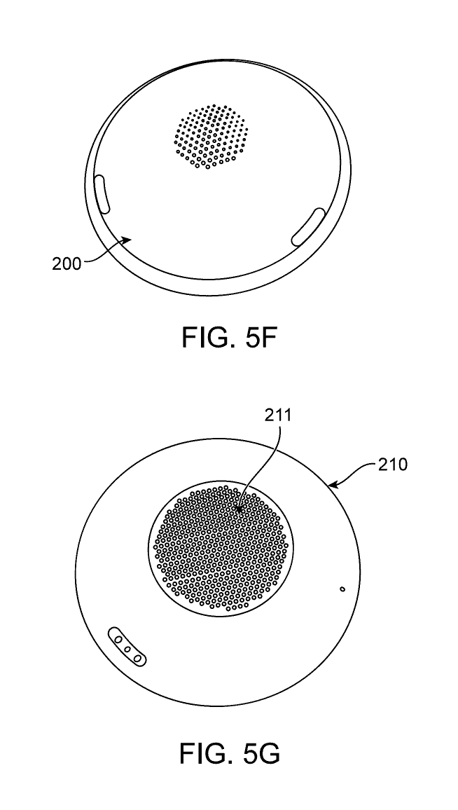

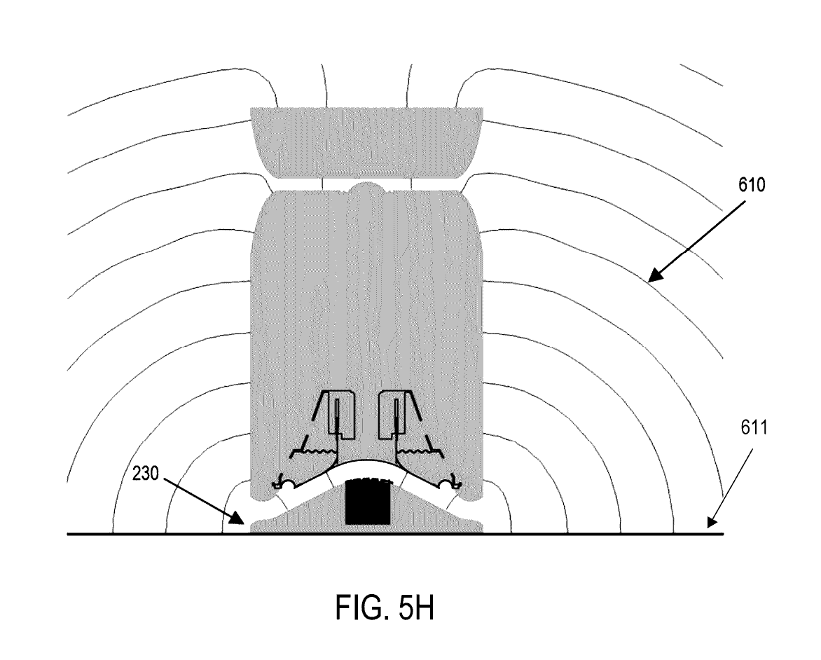

FIG. 5A illustrates a cross-section of another example modified phase plug 200 for an omnidirectional loudspeaker 100, wherein the modified phase plug 200 includes a flat shaped absorber without a perforated plate, in accordance with an embodiment. The modified phase plug 200 comprises a base 200B including an acoustic resonator 209 filled with acoustic damping material 208. The resonator 209 and the acoustic damping material 208 combined provide a physical acoustic filter. The resonator 209 has a flat upper surface (i.e., flat top) 200T. The acoustic damping material 208 is exposed to air in the cavity 109. In one embodiment, a retaining structure (e.g., a wire mesh) may be used to maintain the acoustic damping material 208 in place and prevent the acoustic damping material 208 from falling out of the resonator 209. The retaining structure does not affect the acoustics of the loudspeaker (e.g., does not affect acoustic damping).

FIG. 5B illustrates a cross-section of another example modified phase plug 210 for an omnidirectional loudspeaker 100, wherein the modified phase plug 210 includes a flat shaped absorber with a perforated plate, in accordance with an embodiment. The modified phase plug 210 comprises a base 210B including an acoustic resonator 219 filled with acoustic damping material 218. The resonator 219 and the acoustic damping material 218 combined provide a physical acoustic filter. The resonator 219 has a flat upper surface 210T.

A perforated plate 211 is attached to (partially) cover the flat upper surface 210T to increase effective acoustic damping and maintain the acoustic damping material 218 in place. The perforated plate 211 improves performance of the acoustic filter and acts as a barrier for the acoustic damping material 218, preventing the acoustic damping material 218 from falling out of the resonator 219. A shape of the perforated plate 211 may be based on a diameter W4 of the resonator 219 and a thickness of the perforated plate 211. The perforated plate 211 may include one or more openings/holes spaced regularly or irregularly across the perforated plate 211. The openings/holes allow soundwaves to propagate into the resonator 219. An open-ratio of the perforated plate 211 (i.e., a ratio indicating how much of the perforated plate 211 includes openings/holes) and a diameter of each opening/hole may be based on application and/or size of the loudspeaker 100. In one embodiment, the diameter of each opening/hole may be less than 2 mm and the open-ratio of the perforated plate 211 may be less than 0.6.

FIG. 5C illustrates a cross-section of another example modified phase plug 220 for an omnidirectional loudspeaker 100, wherein the modified phase plug 220 includes a curved shaped absorber without a perforated plate, in accordance with an embodiment. The modified phase plug 220 comprises a base 220B including an acoustic resonator 229 filled with acoustic damping material 228. The resonator 229 and the acoustic damping material 228 combined provide a physical acoustic filter. The resonator 229 has a curved upper surface (i.e., curved top) 220T. The acoustic damping material 228 is exposed to air in the cavity 109. In one embodiment, a retaining structure (e.g., a wire mesh) may be used to maintain the acoustic damping material 228 in place and prevent the acoustic damping material 228 from falling out of the resonator 229. The retaining structure does not affect the acoustics of the loudspeaker (e.g., does not affect acoustic damping).

A dimension of the resonator 229 may vary over a range. The curved upper surface 220T increases a dimension (e.g., height/depth) of the resonator 229.

FIG. 5D illustrates a cross-section of another example modified phase plug 230 for an omnidirectional loudspeaker 100, wherein the modified phase plug 230 includes a curved shaped absorber with a perforated plate, in accordance with an embodiment. The modified phase plug 230 comprises a base 230B including an acoustic resonator 239 filled with acoustic damping material 238. The resonator 239 and the acoustic damping material 238 combined provide a physical acoustic filter. The resonator 239 has a curved upper surface 230T.

A perforated plate 231 is attached to a portion of the modified phase plug (e.g., the curved upper surface 230T) to increase effective acoustic damping and maintain the acoustic damping material 238 in place. The perforated plate 231 improves performance of the acoustic filter and acts as a barrier for the acoustic damping material 238, preventing the acoustic damping material 238 from falling out of the resonator 239. A shape of the perforated plate 231 may be based on a diameter W5 of the resonator 239 and a thickness of the perforated plate 231. The perforated plate 231 may include one or more openings/holes spaced regularly or irregularly across the perforated plate 231. The openings/holes allow soundwaves to propagate into the resonator 239. An open-ratio of the perforated plate 231 (i.e., a ratio indicating how much of the perforated plate 231 includes openings/holes) and a diameter of each opening/hole may be based on application and/or size of the loudspeaker 100. In one embodiment, the diameter of each opening/hole may be less than 2 mm and the open-ratio of the perforated plate 231 may be less than 0.6.

FIG. 5E is another example graph 250 illustrating multiple frequency response curves, in accordance with one embodiment. Specifically, the graph 250 shows a first frequency response curve 251 for a loudspeaker 100 without a physical acoustic filter, a second frequency response curve 252 for a loudspeaker 100 with a curved shaped absorber with a perforated plate, and a third frequency response curve 253 for a loudspeaker 100 with a flat shaped absorber with a perforated plate. As demonstrated by the second and third frequency response curves 252 and 253, modified phase plugs 210 and 230 reduce magnitude of peaks and dips in a frequency response curve for a loudspeaker 100, thereby enhancing sound quality of the loudspeaker 100.

FIG. 5F illustrates a top view of an example modified phase plug 200 for an omnidirectional loudspeaker 100, wherein the modified phase plug 200 includes a curved shaped absorber with a perforated plate, in accordance with an embodiment.

FIG. 5G illustrates a top view of an example modified phase plug 210 for an omnidirectional loudspeaker 100, wherein the modified phase plug 210 includes a flat shaped absorber with a perforated plate 211, in accordance with an embodiment.

FIG. 5H illustrates sound pressure wave fronts 610 around an omnidirectional loudspeaker 100 in operation, in accordance with an embodiment. The loudspeaker 100 is rested on top of a flat surface 611. The loudspeaker 100 includes a modified phase plug 230.

One embodiment provides a protruding phase plug for an omnidirectional loudspeaker 100. FIGS. 6A-6B each illustrate a cross-section of an example protruding phase plug 305 for an omnidirectional loudspeaker 100, in accordance with an embodiment. The protruding phase plug 305 comprises a base 305B and a protruding portion 305P extending from a central area of the base 305B. The protruding portion 305P extends into an interior cavity 102A (FIG. 1) of a first enclosure 102 of the loudspeaker 100.

Specifically, as shown in FIGS. 6A-6B, the protruding portion 305P extends past the diaphragm 106 (in a rest position) of the loudspeaker 100, and into the region 106S (FIG. 1) of space between the diaphragm 106 and the transducer 107 of the loudspeaker 100. The diaphragm 106 includes an opening 106H (i.e., a hole) shaped for receiving the protruding portion 305P. The opening 106H is positioned at a center of the diaphragm 106.

The protruding phase plug 305 provides a physical acoustic filter comprising a resonator 309 filled with acoustic damping material 308.

In this specification, a₂ denotes an amount (i.e., quantity) of the acoustic damping material 308 used to fill the resonator 309, t₂ denotes a type of the acoustic damping material 308, w₂ denotes a first dimension (e.g., diameter) of the resonator 309, and h₂ denotes a second dimension (e.g., height) of the resonator 309. The dimensions w₂ and h₂ of the resonator 309 and the amount a₁ of the acoustic damping material 308 are not limited to any specific range.

Examples of types of acoustic damping material 308 may include, but are not limited to, fiberglass, Dacron, rockwool, glasswool, foam (e.g., polyethylene foam), and mineral wool. The resonator 308 may comprise only one type of acoustic damping material 308 or a combination of different types of acoustic damping material 308. For example, in one embodiment, fiberglass is used to fully fill the resonator 309.

To manufacture the protruding phase plug 305, a shape of the resonator 309, dimensions w₂ and h₂ of the resonator 309, type t₂ of acoustic damping material 308 to use, and amount a₂ of the acoustic damping material 308 to fill the resonator 309 with are determined based on an application and/or size of the loudspeaker 100.

In one example embodiment, a cross-section of the resonator 309 has, but is not limited to, one of the following three-dimensional (3D) shapes: a sphere (see FIG. 7B as an example), a rectangular prism (see FIG. 7D as an example), a cylinder (see FIG. 7A as an example), an undefined shape (see FIG. 7E as an example), etc.

In one example implementation, the resonator 309 is a rectangular prism with a height of 50 mm and a diameter of 15 mm.

FIG. 6C is another example graph 350 illustrating multiple frequency response curves, in accordance with one embodiment. Specifically, the graph 350 shows a first frequency response curve 351 for a loudspeaker 100 without a physical acoustic filter, and a second frequency response curve 352 for a loudspeaker 100 with a protruding phase plug 305. The first frequency response curve 351 includes a peak A₂ around 1500 Hz, a dip B₂ around 4000 Hz, and additional dips C₂ and D₂ around 6000 Hz and 9000 Hz respectively. By comparison, as shown by the second frequency response curve 352, the peak A₂ around 1500 Hz and the dip B₂ around 4000 Hz are eliminated, and the additional dips C₂ and D₂ around 6000 Hz and 9000 Hz respectively are greatly reduced for a loudspeaker 100 with a protruding phase plug 305. Therefore, a protruding phase plug 305 reduces magnitude of peaks and dips in a frequency response curve for a loudspeaker 100, thereby enhancing sound quality of the loudspeaker 100.

FIG. 6D illustrates a cross-section of the protruding phase plug 305 with a perforated ring 410W, in accordance with an embodiment. To increase effective acoustic damping of the resonator 309, a single encircling perforated ring 410W may be attached to an exposed region 305E (FIG. 6F) of the protruding portion 305P that is exposed to air.

FIG. 6E illustrates a cross-section of the protruding phase plug 305 with a perforated ring 410W and an extended absorber 416, in accordance with an embodiment. In one embodiment, the base 305B may be filled with additional acoustic damping material to form an extended absorber 416. The extended absorber 416 helps to attenuate peaks at lower frequencies.

FIG. 6F illustrates a cross-section of the protruding phase plug 305 with an extended absorber 416 and without a perforated ring, in accordance with an embodiment. Some acoustic damping material inside the protruding portion 305P is in direct contact with air surrounding an exposed region 305E of the protruding portion 305P.

FIG. 6G each illustrate a cross-section of an example protruding phase plug 505 for an omnidirectional loudspeaker 100, in accordance with an embodiment. The protruding phase plug 505 comprises a base 505B and a protruding portion 505P extending from a central area of the base 305B. Unlike the protruding phase plug 305, the protruding portion 505P extends only into the cavity 109. The protruding phase plug 505 provides a physical acoustic filter comprising a resonator 509 filled with acoustic damping material 508. The protruding phase plug 505 has a curved upper surface 510T.

FIG. 6H illustrates a cross-section of the protruding phase plug 505 with a perforated plate 510W, in accordance with an embodiment. To increase effective acoustic damping of the resonator 509, a perforated ring 410W may be attached to a region of the protruding portion 505P that is exposed to air.

FIG. 7A illustrates a cross-section of an example modified phase plug 700 comprising a cylindrical shaped resonator 709, in accordance with an embodiment. As shown in FIG. 7A, the resonator 709 lies flush inside the modified phase plug 700 (i.e., does not extend/protrude into the cavity 109).

In this specification, f_{amplify} denotes frequencies (in units of Hz) amplified by a resonator, fₐₜₜₑₙᵤₐₜₑ denotes frequencies (in units of Hz) attenuated by the resonator, n denotes an integer number, and v denotes speed of sound in air in units of meters/second.

In one embodiment, for a cylindrical shaped resonator 709, f_{amplify} is represented in accordance with equation (1) provided below:

f_{amplify}=nv/[4(L+0.4d], (1)

wherein L denotes a length of the resonator 709 in units of meter, d denotes a diameter of the resonator 709 in units of meter, and n is an odd integer number.

In one embodiment, for a cylindrical shaped resonator 709, fₐₜₜₑₙᵤₐₜₑ is represented in accordance with equation (2) provided below:

fₐₜₜₑₙᵤₐₜₑ=nv/[4(L+0.4d)], (2)

wherein n is an even integer number.

FIG. 7B illustrates a cross-section of an example modified phase plug 710 comprising a spherical shaped resonator 719, in accordance with an embodiment. As shown in FIG. 7B, the resonator 719 lies flush inside the modified phase plug 710 (i.e., does not extend/protrude into the cavity 109).

The resonator attenuates frequencies (in units of Hz) around f_{resonance}. In one embodiment, for a spherical shaped resonator 719, f_{resonance} is represented in accordance with equation (3) provided below:

f_{resonance}=(v/π)*(3d/6.8D³)^{1/2}, (3)

wherein D denotes a diameter at a center of the resonator 719 in units of meter, and d denotes a diameter at a top section 715 of the resonator 719 in units of meter.

FIG. 7C illustrates a cross-section of an example modified phase plug 720 comprising a Helmholtz resonator, in accordance with an embodiment. As shown in FIG. 7C, the Helmholtz resonator comprises a spherical resonator 728 including a cylindrical neck 729 extending from a top of the spherical resonator 728. The Helmholtz resonator lies flush inside the modified phase plug 720 (i.e., does not extend/protrude into the cavity 109).

In one embodiment, for a Helmholtz resonator, f_{resonance} is represented in accordance with equation (4) provided below:

f_{resonance}=(v/π)*(A/V₀L_{eq})^{1/2}, (4)

wherein A denotes a cross-sectional area of the neck 729, L denotes a length of the neck 729, V₀ denotes a volume of the resonator 728, L_{eq} is either L+0.75d (if the neck 729 is unflanged, i.e., the neck 729 protrudes into the cavity 109) or L+0.85d (if the neck 729 is flanged, i.e., the neck 729 ends at a surface of the modified phase plug 720), and d denotes a diameter of the neck 729.

FIG. 7D illustrates a cross-section of an example modified phase plug 730 comprising a rectangular prism shaped resonator 739, in accordance with an embodiment. The resonator 739 lies flush inside the modified phase plug 730 (i.e., does not extend/protrude into the cavity 109).

FIG. 7E illustrates a cross-section of an example modified phase plug 740 comprising an irregular shaped resonator 749, in accordance with an embodiment. As shown in FIG. 7E, a top section 749T, a middle section 749M, and a bottom section 749B of the resonator 749 have different shapes. The resonator 749 lies flush inside the modified phase plug 740 (i.e., does not extend/protrude into the cavity 109).

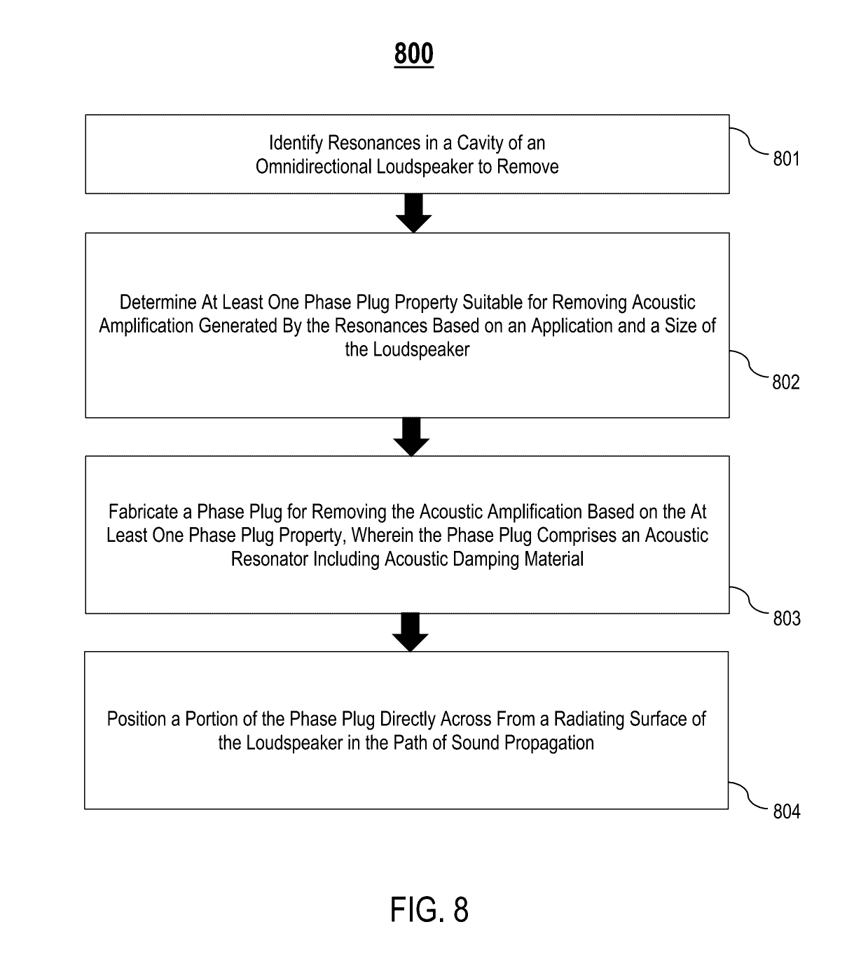

FIG. 8 is an example flowchart of a manufacturing process 800 for producing a phase plug for an omnidirectional loudspeaker, in accordance with an embodiment of the invention. In process block 801, identify resonances in a cavity of the omnidirectional loudspeaker to remove.

In process block 802, determine at least one phase plug property suitable for removing acoustic amplification generated by the resonances based on an application and a size of the omnidirectional loudspeaker.

In process block 803, fabricate a phase plug for removing the acoustic amplification based on the at least one phase plug property, wherein the phase plug comprises an acoustic resonator including acoustic damping material.

In process block 804, position a portion of the phase plug directly across from a radiating surface of the omnidirectional loudspeaker in the path of sound propagation.

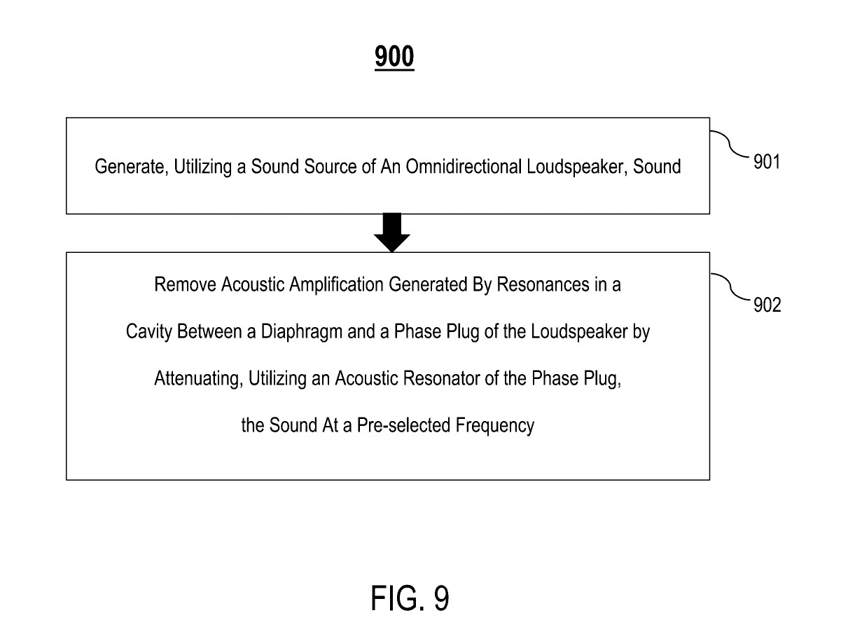

FIG. 9 is an example flowchart 900 for removing acoustic amplification in a cavity between a diaphragm and a phase plug of an omnidirectional loudspeaker, in accordance with an embodiment of the invention. In process block 901, generate, utilizing a sound source of the omnidirectional loudspeaker, sound.

In process block 902, remove acoustic amplification generated by resonances in the cavity by attenuating, utilizing an acoustic resonator of the phase plug, the sound at a pre-selected frequency

Though the embodiments have been described with reference to certain versions thereof; however, other versions are possible. Therefore, the spirit and scope of the appended claims should not be limited to the description of the preferred versions contained herein.

What is claimed is:

1. An omnidirectional loudspeaker, comprising:
a phase plug; and
an acoustic resonator within the phase plug,
wherein the acoustic resonator comprises acoustic damping material.

2. The omnidirectional loudspeaker of claim 1, wherein the acoustic resonator is tuned to attenuate sound at a pre-selected frequency.

3. The omnidirectional loudspeaker of claim 1, further comprising a radiating surface, wherein a portion of the phase plug is positioned in the path of sound propagation, and the acoustic resonator removes acoustic amplification created by resonances in a cavity between the radiating surface and the portion of the phase plug.

4. The omnidirectional loudspeaker of claim 3, wherein the acoustic damping material tunes a Q-factor of attenuation to a Q-factor of the resonances in the cavity.

5. The omnidirectional loudspeaker of claim 3, wherein the acoustic resonator has a curved upper surface.

6. The omnidirectional loudspeaker of claim 5, wherein a perforated plate conforms to the curved upper surface.

7. The omnidirectional loudspeaker of claim 1, wherein the acoustic resonator has a flat upper surface.

8. The omnidirectional loudspeaker of claim 7, wherein a perforated plate is on the flat upper surface.

9. The omnidirectional loudspeaker of claim 1, further comprising:
an axisymmetric loudspeaker enclosure;
a radiating surface disposed inside the axisymmetric loudspeaker enclosure; and
a transducer disposed inside the axisymmetric loudspeaker enclosure;
wherein a portion of the phase plug is positioned in the path of sound propagation, and the phase plug includes a protruding portion that extends through a recess of the radiating surface and into a region of space between the radiating surface and a former of the transducer inside the axisymmetric loudspeaker enclosure.

10. The omnidirectional loudspeaker of claim 9, wherein a perforated ring is attached to a region of the protruding portion exposed to air in a cavity between the radiating surface and the phase plug.

11. The omnidirectional loudspeaker of claim 1, wherein a base of the phase plug comprises additional acoustic damping material.

12. A method for producing a phase plug for an omnidirectional loudspeaker, comprising:
identifying resonances in a cavity of the omnidirectional loudspeaker to remove; and
fabricating a phase plug for removing acoustic amplification generated by the resonances, wherein the phase plug comprises an acoustic resonator including acoustic damping material.

13. The method of claim 12, further comprising:
determining at least one phase plug property suitable for removing the acoustic amplification based on an application and a size of the omnidirectional loudspeaker, wherein the phase plug is fabricated based on the at least one phase plug property.

14. The method of claim 13, wherein the determining at least one phase plug property comprises:
determining a shape of the acoustic resonator;
determining a dimension of the acoustic resonator;
determining a type of the acoustic damping material; and
determining an amount of the acoustic damping material required to fill the acoustic resonator.

15. The method of claim 12, further comprising:
positioning a portion of the phase plug directly across from a radiating surface of the omnidirectional loudspeaker in the path of sound propagation.

16. The method of claim 15, wherein the phase plug includes a protruding portion that extends into the cavity.

17. The method of claim 16, further comprising:
attaching perforated ring to a region of the protruding portion exposed to air in the cavity.

18. The method of claim 12, further comprising:
tuning the acoustic resonator to attenuate sound generated by a sound source of the omnidirectional loudspeaker at a pre-selected frequency.

19. A method for removing acoustic amplification in a cavity between a diaphragm and a phase plug of an omnidirectional loudspeaker, comprising:
generating, utilizing a sound source of the omnidirectional loudspeaker, sound; and
removing acoustic amplification generated by resonances in the cavity by attenuating, utilizing an acoustic resonator of the phase plug, the sound at a pre-selected frequency, wherein the acoustic resonator comprises an acoustic damping material.

20. The method of claim 19, wherein the acoustic damping material tunes a Q-factor of attenuation to a Q-factor of the resonances in the cavity.
